(19) United States
(12) Patent Application Publication
(10) Pub. No.: US 2005/0151747 A1
(43) Pub. Date: Jul. 14, 2005

(54) 3D object graphics processing apparatus and 3D scene graph processing apparatus

(75) Inventors: Do-kyoon Kim, Gyeonggi-do (KR); Mahn-jin Han, Gyeonggi-do (KR); Jeong-hwan Ahn, Seoul (KR); Sang-oak Woo, Gyeonggi-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 10/963,551

(22) Filed: Oct. 14, 2004

Related U.S. Application Data
(60) Provisional application No. 60/510,146, filed on Oct. 14, 2003.

(30) Foreign Application Priority Data
Oct. 11, 2004 (KR) 2004-81061

(51) Int. Cl. G06T 1/20

(52) U.S. Cl. 345/506

(57) ABSTRACT

Provided are a 3D object graphics processing apparatus and a 3D scene graph processing apparatus. A 3D object graphics processing apparatus includes: an Appearance processing unit defining an appearance of a 3D object; a Material processing unit defining material of the appearance of the 3D object; an IndexedFaceSet processing unit defining the 3D object by using faces formed in coordinates; an IndexedLineSet processing unit defining the 3D object by using lines formed in the coordinates; a Color processing unit defining colors of the 3D object; a Coordinate processing unit defining the coordinates of the 3D object; a TextureCoordinate processing unit defining coordinate values for a texture of the appearance of the 3D object; a DirectionalLight processing unit defining a light illuminated from an infinitely distant light source in a predetermined direction in parallel; a PointLight processing unit defining a light generated from a single point source and illuminated symmetrically to all directions; a SpotLight processing unit defining a light generated from a single point source and illuminated in a particular direction within a predetermined angle range; and a Shape processing unit defining a shape of the 3D object of which the appearance has been already defined by the Appearance processing unit. Therefore, it is possible to create a 3D object by using a small number of 3D object graphics tools, so that burdens on a memory device and the size and weight of hardware can be reduced.

### BACKGROUND OF THE INVENTION

This application claims the priority of Korean Patent Application No. 2004-81061, filed on Oct. 11, 2004, in Korean Intellectual Property. Office, and the benefit of U.S. provisional Patent Application No. 60/510,146, filed on Oct. 14, 2003, in U.S. Patent and Trademark Office, the disclosures of which are incorporated herein in their entirety by reference.

1. Field of the Invention

The present invention relates to a 3D graphics rendering, and more particularly, to a 3D object graphics processing apparatus and a 3D scene graph processing apparatus, for rendering a 3D object or a 3D scene using a small number of tools,

2. Description of Related Art

Typically, 3D graphics data contains information on geometry, material attributes, location and properties of a light source, and a history of these data in relation to a 3D object attached to a 3-dimensional virtual universe. Such information is usually represented in a logically and intuitively recognizable structure, called a scene graph, so that a user can create and modify the 3D graphic data without difficulty. A scene graph consists of nodes, including information on geometry or material of the object, and connection states of the nodes hierarchically arranged in a tree structure. In other words, a node is a fundamental component of a scene graph. A field is used to define attributes of the node in detail. In other words, the 3D object graphics processing apparatus creates the 3D object in a virtual universe, and the 3D scene graph processing apparatus creates a scene graph by using the hierarchical data of the 3D object.

Conventional 3D graphics technologies have visualized and animated only a simple 3D model. However, development of recent technologies makes it possible to animate natural phenomena such as water, wind, and smoke, and even motions of human hairs and clothes, so that developer's imagination can be easily expressed and presentation in a virtual universe is made to be free.

Unfortunately, there are still a lot of tools used in such 3D graphics technologies, and particularly a lot of useless tools, so that a conventional 3D object graphics processing apparatus or a conventional 3D scene graph processing apparatus has a huge amount of burdens on a memory device, and thus increasing the size and weight of hardware.

### SUMMARY OF INVENTION

The present invention provides a 3D object graphic processing apparatus capable of creating a 3D object by using a small number of 3D object graphics tools.

In addition, the present invention provides a 3D scene graph processing apparatus capable of creating a 3D scene by using a small number of 3D scene graph tools.

According to an aspect of the present invention, there is provided a 3D object graphics processing apparatus comprising: an Appearance processing unit defining an appearance of a 3D object; a Material processing unit defining material of the appearance of the 3D object; an IndexedFaceSet processing unit defining the 3D object by using faces formed in coordinates; an IndexedLineSet processing unit defining the 3D object by using lines formed in the coordinates; a Color processing unit defining colors of the 3D object; a Coordinate processing unit defining the coordinates of the 3D object; a TextureCoordinate processing unit defining coordinates for a texture of the appearance of the 3D object; a DirectionalLight processing unit defining a light illuminated from an infinitely distant light source in a predetermined direction in parallel; a PointLight processing unit defining a light generated from a single point source and illuminated symmetrically to all directions; a SpotLight processing unit defining a light generated from a single point source and illuminated in a particular direction within a predetermined angle range; and a Shape processing unit defining a shape of the 3D object of which the appearance has been already defined by the Appearance processing unit.

According to another aspect of the present invention, there is provided a 3D scene graph processing apparatus comprising: a Group processing unit defining inclusion of child nodes; a Transform processing unit defining a hierarchical coordinate system of the child nodes in relation to a parent node; a CoordinateInterpolator processing unit defining changes of coordinates of a 3D object; an OrientationInterpolator processing unit defining changes of an orientation of the 3D object; a PositionInterpolator processing unit defining changes of a position of the 3D object; a ScalarInterpolator processing unit defining changes of scalar values of the 3D object; a TouchSensor processing unit defining generation of an event caused by a contact of a pointing device to the 3D object; a TimeSensor processing unit defining generation of an event caused by a time lapse; a DEF processing unit defining generation of node names; a USE processing unit defining uses of the nodes; a NavigationInfo processing unit defining operations of the 3D object on a 3D scene; a ViewPoint processing unit defining a position viewing the 3D scene; a ROUTE processing unit defining a path for delivering an event between the nodes; a WorldInfo processing unit defining descriptions of the 3D scene; a QuantizationParameter processing unit defining a compression ratio of the 3D scene; and a SceneUpdate processing unit defining an update of the 3D scene.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a 3D object graphics processing apparatus according to an embodiment of the present invention;

FIG. 2 illustrates exemplary textures created by a ProceduralTexture processing unit of FIG. 1 according to an embodiment of the present invention;

FIG. 3 is a table for comparing tools of the 3D object graphics processing apparatus according to the present invention with those of a conventional 3D object graphics processing apparatus;

FIG. 4 illustrates an exemplary table setting up different parameters of a 3D object graphics processing apparatus according to the present invention depending on performances of an application device;

FIG. 5 illustrates an exemplary table indicating restrictions, (i.e., maximum values) on the parameters for tools of a 3D object graphics processing apparatus according to the present invention;

FIG. 6 is a block diagram illustrating a 3D scene graph processing apparatus according to an embodiment of the present invention;

FIG. 7 is a table for comparing tools of the 3D scene graph processing apparatus according to the present invention with those of a conventional 3D scene graph processing apparatus;

FIG. 8 illustrates an exemplary table setting up different parameters of a 3D scene graph processing apparatus according to the present invention depending on performances of an application device; and

FIG. 9 illustrates an exemplary table indicating restrictions, (i.e., maximum values) on the parameters for tools of a 3D scene graph processing apparatus according to the present invention.

### DETAILED DESCRIPTION OF THE INVENTION

Now, a 3D object graphics processing apparatus according to the present invention will be described in detail with reference to the accompanying drawings.

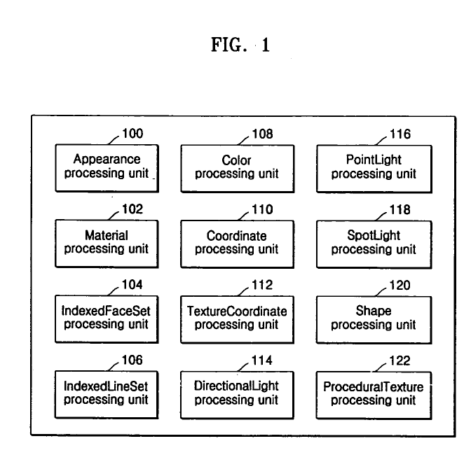

FIG. 1 is a block diagram illustrating a 3D object graphics processing apparatus according to an embodiment of the present invention. A 3D object graphics processing apparatus includes an Appearance processing unit 100, a Material processing unit 102, an IndexedFaceSet processing unit 104, an IndexedLineSet processing unit 106, a Color processing unit 108, a Coordinate processing unit 110, a TextureCoordinate processing unit 112, a DirectionalLight processing unit 114, a PointLight processing unit 116, a SpotLight processing unit 118, a Shape processing unit 120, and a ProceduralTexture processing unit 122.

The Appearance processing unit 100 defines an appearance of a 3D object. For this purpose, the Appearance processing unit 100 organizes an Appearance node having a Material field. The Material field designates a Material node.

The Material processing unit 102 defines material attributes of the appearance of a 3D object. For this purpose, the Material processing unit 102 organizes a Material node. The Material node is a node designating material used to define the appearance of the 3D object, and will be used to calculate the amount of a light when a 3D object is created.

The IndexedFaceSet processing unit 104 defines the 3D object by using faces formed in coordinates. For this purpose, the IndexedFaceSet processing unit 104 organizes an IndexedFaceSet node. The IndexFaceSet node specifies a plurality of 3D coordinates by using the Coordinate node. Then, one or more faces are created by using the specified 3D coordinates, and appropriate colors are selected for the created faces.

The IndexedLineSet processing unit 106 defines the 3D object by using lines formed in the coordinates. For this purpose, the IndexedLineSet processing unit 106 organizes an IndexedLineSet node. The IndexedLineSet node specifies a plurality of 3D coordinates by using the Coordinate node. Then, the lines are created by using the specified 3D coordinates, and appropriate colors are selected.

The Color processing unit 108 defines colors of the 3D object. For this purpose, the Color processing unit 108 organizes a color node. The color node specifies RGB colors of the 3D object.

The Coordinate processing unit 110 defines the coordinates of the 3D object. For this purpose, the coordinate processing unit 110 organizes a Coordinate node. The Coordinate node specifies 3D coordinates in the fields of the IndexedFaceSet node and the IndexedLineSet node that define the 3D object based on the coordinate values.

The TextureCoordinate processing unit 112 defines coordinates of a texture of the appearance of the 3D object. For this purpose, the TextureCoordinate processing unit 112 organizes a TextureCoordinate node.

The DirectionalLight processing unit 114 defines a light illuminated from an infinitely distant light source in a particular direction in parallel. For this purpose, the DirectionalLight processing unit 114 organizes a DirectionalLight node. The DirectionalLight node specifies a light intensity, a light color, an illuminating direction, and an ambient brightness. The directional light influences all child or descendent nodes in only a group to which the corresponding DirectionalLight node belongs.

The PointLight processing unit 116 defines a light generated from a single point source and illuminated symmetrically to every direction. For this purpose, the PointLight processing unit 116 organizes a PointLight node. The PointLight node specifies a light transmitted symmetrically to every direction.

The SpotLight processing unit 118 defines a light generated from a signal point source and illuminated to a particular direction within a predetermined angle range. For this purpose, the SpotLight processing unit 118 organizes a SpotLight node. The SpotLight node specifies a location of the point source in a 3D coordinate system, a distance that the light can arrive, and an angle that the light is transmitted.

The Shape processing unit 120 defines a shape of the 3D object of which the appearance has been already defined by the Appearance processing unit 100. For this purpose, the Shape processing unit 120 organizes a Shape node. The Shape node specifies a shape of the 3D object in consideration of the material specified in the Material node by the Appearance processing unit 100.

The ProceduralTexture processing unit 122 creates various textures by using a texture generation function, and defines a texture of the 3D object by using the created textures. Also, appropriate parameters are given to the texture generation function. More specifically, a fractal plasma field is selected and distributed to textures subdivided into a plurality of cells. Then, a spatial distortion is applied to the textures to add colors, thus creating a final texture.

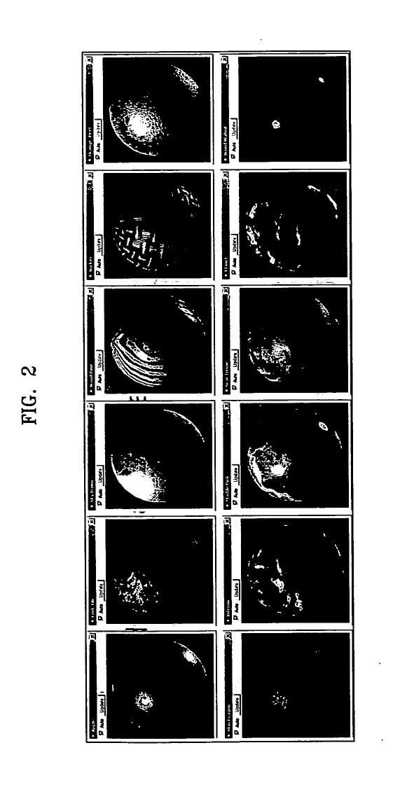

FIG. 2 illustrates textures created by the ProceduralTexture processing unit of FIG. 1 according to an embodiment of the present invention. It is recognized that the ProceduralTexture processing unit according to the present invention can create various textures by using a small amount of data. Therefore, it is possible to provide various textures for a 3D object in comparison with conventional arts.

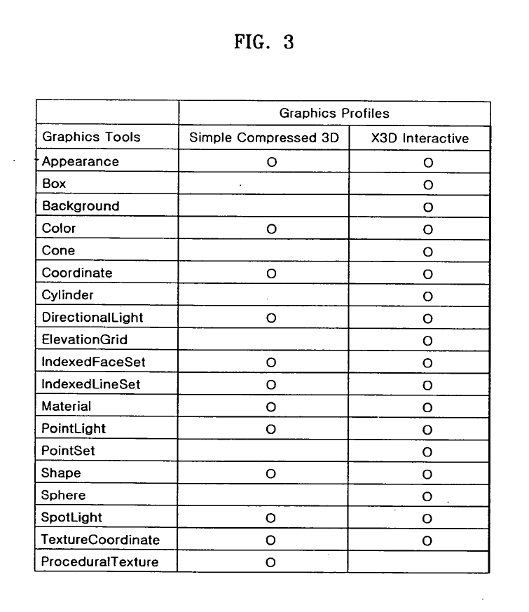

FIG. 3 is a table for comparing tools of the 3D object graphics processing apparatus according to the present invention with those of a conventional 3D object graphics processing apparatus. In FIG. 3, the tools of the 3D object graphics processing apparatus according to the present invention are represented by “Simple Compressed 3D”, while those of the conventional 3D object graphics processing apparatus are represented by “X3D Interactive”.

As shown in FIG. 3, the 3D object graphics processing apparatus according to the present invention does not have “Box Tool”, “Background Tool”, “Cone Tool”, “Cylinder Tool”, ElevationGrid Tool”, “PointSet Tool”, and “Sphere Tool” in comparison with the conventional 3D object graphics processing apparatus. As a result, it is possible to reduce burdens of hardware such as a memory device for storing a plurality of 3D object graphics tools and also the size and weight of hardware. Instead, the 3D object graphics processing apparatus according to the present invention further includes the ProceduralTexture processing unit 122, so that various textures can be obtained from a small amount of data.

On the other hand, the 3D object graphics processing apparatus according to the present invention allows us to set up different parameters depending on performance requirements or specifications of the application devices employing the present apparatus. For example, the parameters may be set up as a high level when an application device supports a high performance or a high definition. On the contrary, the parameters may be set up as a low level when an application device does not support a high performance of a high definition.

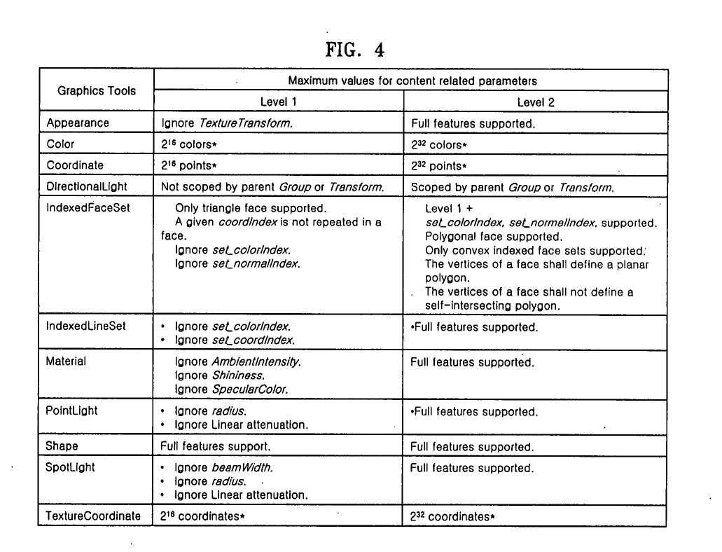

FIG. 4 illustrates an exemplary table setting up different parameters for tools of a 3D object graphics processing apparatus according to the present invention depending on performances of an application device. Level 1 represents a low level in which each parameter is set up for a low performance application device, and Level 2 represents a high level in which each parameter is set up for a high performance application device.

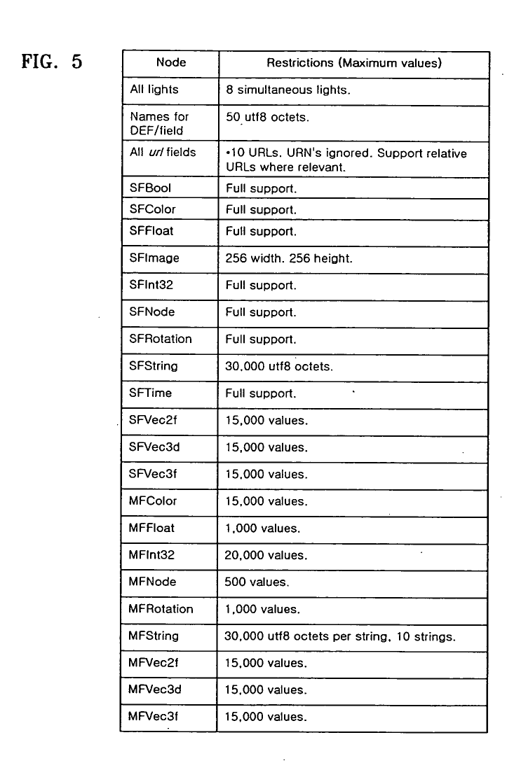

FIG. 5 illustrates an exemplary table indicating restrictions, (i.e., maximum values) on the parameters of the 3D object graphics processing apparatus according to the present invention. The 3D object graphics processing apparatus according to the present invention can create 3D object graphics under these restrictions. Also, these restrictions can be substituted with appropriate values depending on available resources or a processor performance, and the present invention is not limited by these.

Now, a 3D scene graph processing apparatus according to the present invention will be described with reference to the attached drawings.

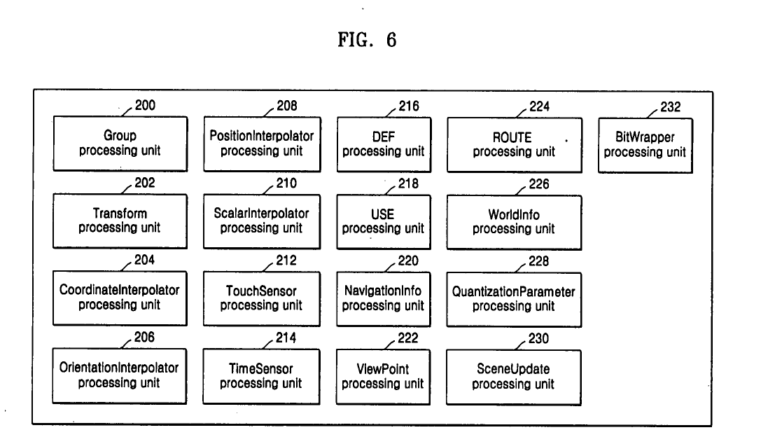

FIG. 6 is a block diagram illustrating a 3D scene graph processing apparatus according to an embodiment of the present invention. The 3D scene graph processing apparatus includes a Group processing unit 200, a Transform processing unit 202, a CoordinateInterpolator processing unit 204, an OrientationInterpolator processing unit 206, a PositionInterpolator processing nit 208, a ScalarInterpolator processing unit 210, a TouchSensor processing unit 212, a TimeSensor processing unit 214, a DEF processing unit 216, a USE processing unit 218, a NavigationInfo processing unit 220, a Viewpoint processing unit 222, a ROUTE processing unit 224, a WorldInfo processing unit 226, a QuantizationParameter processing unit 228, a SceneUpdate processing unit 230, and a BitWrapper processing unit 232.

The Group processing unit 200 defines whether or not the child nodes should be included. For this purpose, the Group processing unit 200 organizes a Group node.

The Transform processing unit 202 defines a hierarchical coordinate system for the child nodes in relation to the coordinate system of the parent node. For this purpose, the Transform processing unit 202 organizes a Transform node. The Transform node is a grouping node specifying a new coordinate system for the child node in relation to the coordinate system of the parent node.

The CoordinateInterpolator processing unit 204 defines changes of the coordinates of the 3D object. For this purpose, the CoordinateInterpolator processing unit 204 organizes a CoordinateInterpolator node. The CoordinateInterpolator node is a node for expressing changes of the 3D object by changing the coordinates of the 3D object, formed in the IndexedFaceSet processing unit 104 and the IndexedLineSet processing unit 106.

The OrientationInterpolator processing unit 206 defines changes of an orientation of the 3D object. For this purpose, the OrientationInterpolator processing unit 206 organizes an OrientationInterpolator node. The OrientationInterpolator node specifies changes of the orientation of the 3D object in a virtual universe.

The PositionInterpolator processing unit 208 defines changes of a position of the 3D object. For this purpose, the PositionInterpolator processing unit 208 organizes a PositionInterpolator node. The PositionInterpolator node specifies changes of the position of the 3D object in a virtual universe.

The ScalarInterpolator processing unit 210 defines changes of scalar values of the 3D object. For this purpose, the ScalarInterpolator processing unit 210 organizes a ScalarInterpolator node for specifying changes of the scalar values other than the vector values.

The TouchSensor processing unit 212 defines generation of an event caused by a contact of a pointing device to the 3D object. For this purpose, the TouchSensor processing unit 212 organizes a TouchSensor node. The TouchSensor node operates when a user makes contact of the pointing device such as a mouse to the 3D object. For example, when a user selects the 3D object by using the pointing device, a “TRUE” event is generated.

The TimeSensor processing unit 214 defines generation of an event caused by a time lapse. For this purpose, the TimeSensor processing unit 214 organizes a TimeSensor node. The TimeSensor node is used for continuous simulations, animations, periodic operations, and an alarm function. For example, the TimeSensor node generates a “TRUE” event when a time sensor starts to operate, and generates a “FALSE” event when the operation of the time sensor is interrupted.

The DEF processing unit 216 defines generation of node names. The DEF processing unit 216 designates the node names so that information on the nodes can be continuously used in the USE processing unit 21 and ROUTE processing unit 224 which will be described below.

The USE processing unit 218 defines uses of the nodes. The USE processing unit 218 specifies uses of the nodes by using the node names generated by the DEF processing unit 216.

The NavigationInfo processing unit 220 defines operations of the 3D object on the 3D scene. For this purpose, the NavigationInfo processing unit 220 organizes a NavigationInfo node.

The ViewPoint processing unit 222 defines a position viewing the 3D object. For this purpose, the ViewPoint processing unit 22 organizes a ViewPoint node. The ViewPoint node specifies field values that changes according to the position viewing the 3D object.

The ROUTE processing unit 224 defines a path for delivering an event between the nodes.

The WorldInfo processing unit 226 defines descriptions of the 3D scene. For this purpose, the WorldInfo processing unit 226 organizes a WorldInfo node. The WorldInfo node provides text data for descriptions of the 3D scene.

The QuantizationParameter processing unit 228 defines a compression ratio of the 3D scene. The QuantizationParameter processing unit 228 adjusts the quantization parameters according to the compression ratio of the 3D scene.

The SceneUpdate processing unit 230 defines an update of the 3D scene.

The BitWrapper processing unit 232 defines access of the compressed bit stream of the 3D object. The BitWrapper processing unit 232 can access to the compressed bit stream of the 3D object in a particular format such as a binary format for scene (BIFS) stream. The compressed bit stream of the 3D object, accessed by the BitWrapper processing unit 232, creates the 3D scene when decompressed.

The accessed bit stream may be stored in a buffer or other recording media connected via networks. The BitWrapper processing unit 232 accesses to the compressed bit stream of the 3D object, stored in a buffer by using a buffer address. On the other hand, the BitWrapper processing unit 232 accesses to the compressed bit stream of the 3D object, stored in other recording media by using a uniform resource locator (URL) address. The URL address means an address of a server or a particular recording medium where the compressed bit stream of the 3D object is stored.

It should be noted that a conventional 3D scene graph processing apparatus does not have tools for accessing to the compressed bit stream. Therefore, since the 3D object has been accessed with no compression, there were a lot of burdens on data transmissions and storages. On the contrary, the 3D scene graph processing apparatus according to the present invention includes the BitWrapper processing unit 232 allowing access to the compressed bit stream of the 3D object. Therefore, it is possible to reduce time for data transmissions. In addition, since the 3D object data can be stored with compression, it is possible to reduce a memory space.

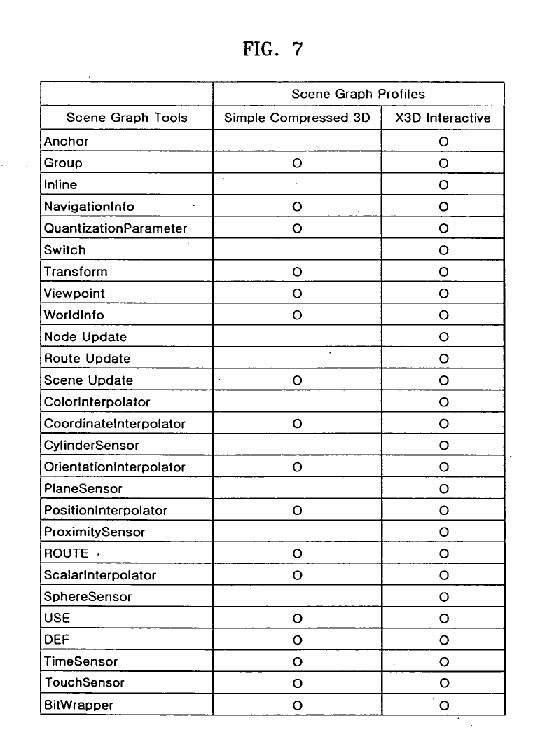

FIG. 7 is a table for comparing tools of the 3D scene graph processing apparatus according to the present invention with those of a conventional 3D scene graph processing apparatus. In FIG. 7, the tools of the 3D scene graph processing apparatus according to the present invention are represented by “Simple Compressed 3D”, while those of the conventional 3D scene graph processing apparatus are represented by “X3D Interactive”.

As shown in FIG. 7, the 3D scene graph processing apparatus according to the present invention does not have “Anchor Tool”, “Inline Tool”, “Switch Tool”, “Node Update Tool”, “Route Update Tool”, “ColorInterpolator Tool”, “CylinderSensor Tool”, “PlaneSensor Tool”, “ProximitySensor Tool”, and “SphereSensor Tool” in comparison with the conventional 3D scene graph processing apparatus. As a result, it is possible to reduce burdens of hardware such as a memory device for storing a plurality of 3D scene graph tools and also the hardware size and weight. Instead, the 3D scene graph processing apparatus according to the present invention further includes the BitWrapper processing unit 232, so that the compressed bit stream of the 3D object can be accessed.

On the other hand, the 3D scene graph processing apparatus according to the present invention allows us to set up different parameters depending on performance requirements or specifications of the application devices employing the present apparatus. For example, the parameters may be set up as a high level when an application device supports a high performance or a high definition. On the contrary, the parameters may be set up as a low level when an application device does not support a high performance of a high definition.

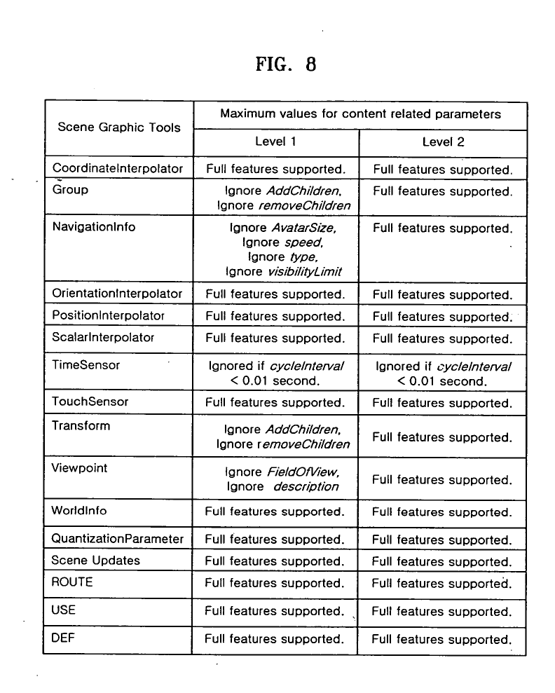

FIG. 8 illustrates an exemplary table setting up different parameters of a 3D scene graph processing apparatus according to the present invention depending on performances of an application device. Level 1 represents a low level in which each parameter is set up for a low performance application device, and Level 2 represents a high level in which each parameter is set up for a high performance application device.

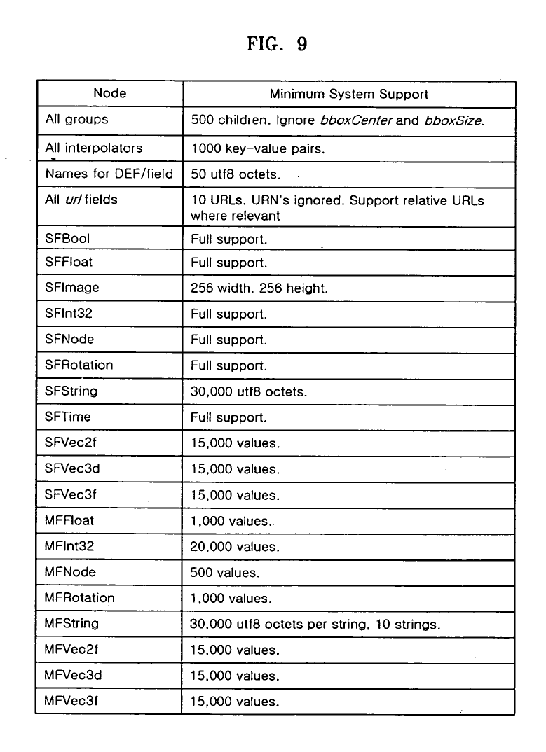

FIG. 9 illustrates an exemplary table indicating restrictions, (i.e., maximum values) on the parameters of the 3D scene graph processing apparatus according to the present invention. The 3D scene graph processing apparatus according to the present invention can create 3D object graphics under these restrictions. Also, these restrictions can be substituted with appropriate values depending on available resources or a processor performance, and the present invention is not limited by these.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A 3D object graphics processing apparatus comprising:
an Appearance processing unit defining an appearance of a 3D object;
a Material processing unit defining material of the appearance of the 3D object;
an IndexedFaceSet processing unit defining the 3D object by using faces formed in coordinates;
an IndexedLineSet processing unit defining the 3D object by using lines formed in the coordinates;
a Color processing unit defining colors of the 3D object;
a Coordinate processing unit defining the coordinates of the 3D object;
a TextureCoordinate processing unit defining coordinates for a texture of the appearance of the 3D object;
a DirectionalLight processing unit defining a light illuminated from an infinitely distant light source in a predetermined direction in parallel;
a PointLight processing unit defining a light generated from a single point source and illuminated symmetrically to all directions;
a SpotLight processing unit defining a light generated from a single point source and illuminated in a particular direction within a predetermined angle range; and
a Shape processing unit defining a shape of the 3D object of which the appearance has been already defined by the Appearance processing unit.

2. The 3D object graphics processing apparatus according to claim 1, further comprising a ProceduralTexture processing unit creating various textures by using a function and defining a texture of the 3D object by using the created textures.

3. The 3D object graphics processing apparatus according to claim 1, wherein parameters of the 3D object graphics processing apparatus are differently set up depending on performance requirements or specifications of the application device employing the 3D object graphics processing apparatus.

4. A 3D scene graph processing apparatus comprising:
a Group processing unit defining inclusion of child nodes;
a Transform processing unit defining a hierarchical coordinate system of the child nodes in relation to a parent node;
a CoordinateInterpolator processing unit defining changes of coordinates of a 3D object;
an OrientationInterpolator processing unit defining changes of an orientation of the 3D object;
a PositionInterpolator processing unit defining changes of a position of the 3D object;
a ScalarInterpolator processing unit defining changes of scalar values of the 3D object;
a TouchSensor processing unit defining generation of an event caused by a contact of a pointing device to the 3D object;
a TimeSensor processing unit defining generation of an event caused by a time lapse;
a DEF processing unit defining generation of node names;
a USE processing unit defining uses of the nodes;
a NavigationInfo processing unit defining operations of the 3D object on a 3D scene;
a ViewPoint processing unit defining a position viewing the 3D scene;
a ROUTE processing unit defining a path for delivering an event between the nodes;
a WorldInfo processing unit defining descriptions of the 3D scene;
a QuantizationParameter processing unit defining a compression ratio of the 3D scene; and
a SceneUpdate processing unit defining an update of the 3D scene.

5. The 3D scene graph processing apparatus according to claim 4, further comprising a BitWrapper processing unit defining access of a compressed bit stream of the 3D object.

6. The 3D scene graph processing apparatus according to claim 4, wherein parameters of the 3D scene graph processing apparatus are differently set up depending on performance requirements or specifications of the application device employing the 3D scene graph processing apparatus.
